(19) United States
(12) Patent Application Publication
(10) Pub. No.: US 2003/0106070 A1
(43) Pub. Date: Jun. 5, 2003

(54) Efficient customization of advertising programs for broadcast TV

(76) Inventor: Homayoon Saam, La Jolla, CA (US)

Correspondence Address: HOMAYOON SAAM, P.O. Box 180, La Jolla, CA, 92038, US

(21) Appl. No.: 10/308,777

(22) Filed: Dec. 3, 2002

Related U.S. Application Data
(60) Provisional application No. 60/337,671, filed on Dec. 5, 2001.
(60) Provisional application No. 60/358,492, filed on Feb. 19, 2002.

(51) Int. Cl. H04N 7/025; H04N 7/10; G06F 3/00; H04N 5/445; G06F 13/00; H04N 7/16

(52) U.S. Cl. 725/135; 725/34; 725/136; 725/47

(57) ABSTRACT

A system and method for efficient communication of customized messages is described which builds upon existing mechanisms for the transmission and playback of advertising programs and enhances the advertising programs by providing customized components of the program in an efficient manner. This scheme reduces the bandwidth requirements and eases the task of production by the advertising producers of a multiplicity of customized advertising messages, each targeting a separate household or groups of households.

### RELATION TO PROVISIONAL PATENT

This patent application relates to the Provisional Patent Application No. 60/337,671 filed on Dec. 5, 2001 and amended by Provisional Patent Application No. 60/358,492 filed on Feb. 19, 2002 both of the same Title and by the same Inventor as this application.

### BACKGROUND OF THE INVENTION

1. Field of the Invention

The invention relates generally to the field of mass media advertising and, more particularly, to an improved method and system for providing customized advertising content to television viewers, based on criteria such as demographics, for example.

2. Description of Related Art

Reception of television (TV) programs in a majority of the households today occurs through either cable TV or satellite TV reception infrastructures. The use of digital compression and transmission technology by cable TV and satellite TV broadcasters is becoming more predominant because of the efficiency in bandwidth utilization and increased capacity for offering new programming channels provided by this technology. As a result, viewers are offered not only traditional broadcast network programs which dominated the analog days of TV (ABC, CBS, NBC) but a large range of special interest programming targeting individual tastes and interests as represented by (CNN, CSPAN, TNT, BRAVO, etc.). Satellite TV has so far had the upper hand in terms of the variety and number of programming channels (up to five hundred channels) offered due to their early adoption of MPEG compression and transmission technologies. However, with the increased penetration of digital cable transmission among households, similar offerings are now becoming available by cable service providers.

The advertising content of broadcast TV represents an important foundation for enabling the consumer-based pricing of the cable and satellite TV services. The ability of the various manufacturers, consumer goods companies, financial institutions and other advertisers to reach millions of households through the ubiquitous TV screen is an important element of the western economies. However, the broadcast nature of these services has meant that advertising is mostly a generic effort targeted at brand awareness and offered to large, non-homogeneous populations which have little in common. While the advent of “theme” channels (such as Women's Entertainment, HGTV) has improved the ability of advertisers to target their audiences, there is still a large gap between the ability of advertisers to provide customized and “localized” advertising today (mostly through local cable service providers) and their desire to provide customized advertising based on demographic parameters such as income, age, geography and the like.

Specifically, two problems have limited the potential offering of customized advertising and the associated return on the advertising dollars. The first is the lack of available bandwidth to provide individualized advertising content. To target households effectively requires customization down to the individual household level. However, this means that in a typical cable TV node serving thousands of households, the bandwidth requirement increases by a large multiple if different content needs to be sent to different households. The second problem is the ability of the advertisers to produce such customized, segmented advertising in a cost-effective manner. For example, a mutual fund institution or an auto manufacturer would highly benefit from a customization of their generic advertising that would address different audiences based on their income levels or geographic location. For example, an auto company could better match its different auto price levels with the income levels of the households by having different commercial messages simultaneously sent to different households. Or the address and phone numbers of local account executives or dealerships could be provided which would be closest to the target household. These would require potentially tens, and perhaps hundreds or thousands, of different versions of a given advertising produced by a single advertiser. This becomes prohibitively expensive if an efficient method of customization is not available.

Prior methods and systems have not provided an effective solution to the problem of providing customized content to target viewers. For example, U.S. Pat. No. 6,029,045 to Picco et al. discloses a system for communicating a programming data stream and a data stream containing pieces of local content data (i.e., customized data) which is then be inserted into a local content space in the programming data stream at some predetermined time. The system disclosed by Picco requires advertisers to significantly alter existing advertising by creating a “local content space” in the existing commercial so that local content data can be “inserted” into this space. This requirement is extremely unattractive to advertisers as they are not inclined to leave a significant “gap” in their commercials which is to be “filled in” by yet to be determined “local content data.” Additionally, Picco's system requires the transmission of local content data that adequately fills the “gap” in the programming data stream. This requires the transmission of various versions of the local content data, depending on the level of customization, containing audio, visual and/or graphic content similar to the existing programming data stream so as to provide a “seamless” insert. It is easy to see that as the number of different versions of the local content data increases, the additional bandwidth requirements for transmitting these commercial “inserts” can be significant. Furthermore, these prior methods require significant additional work on the part of the advertisers to create different versions of local content that effectively targets individual viewers and which can be “inserted” into the primary programming content in an aesthetically pleasing manner.

Thus, there is a need for a method and system for providing customized content to viewers of television that minimally impacts existing advertising content and methods of creating this content, and, furthermore, does not significantly increase bandwidth requirements. Additionally, there is a need for a method and system for efficiently creating customized content, taking into account the large variety of viewer preferences, demographics and other criteria, that requires a minimum amount of additional work by the advertiser.

### SUMMARY OF THE INVENTION

The invention addresses the above and other needs by providing a method and system for providing customized content to television viewers based on any number of various criteria, such as demographics, for example. The method and system of the invention has minimal impact to existing advertising content and techniques for creating existing content and, furthermore, does not require significant increases in bandwidth requirements. Additionally, the invention provides for the efficient creation of customized advertising content with a minimum amount of additional work required on the part of advertisers. Although the invention is described below in the context of television advertising content, it is readily apparent to those of ordinary skill in the art that the method and system of the present invention can be beneficially applied in other contexts such as providing customized content via the Internet, for example.

Typically, television advertising content consists of multiple components of audio (e.g. music), voice, video, graphics, moving graphics (e.g. animation or moving banners) and images. In an advertising program, the highest levels of information are carried by components which represent human language. Since customization of advertising is predominantly a customization of the information carried in that advertising, focusing on those elements of a program is important to achieve efficient customization. In a TV program, language dependent information is typically carried by two mechanisms: human voice and text. Human voice forms part of the audio program received by a viewer. Text is typically displayed through graphics such as still and moving banners, pop-up screens and similar graphic objects.

In accordance with one embodiment of the invention, the method and system creates, transmits and receives the core of a customized message in the text form. The received text is then used by the processing and storage capabilities of a receiver (e.g., customer premises equipment such as a set top box or personal computer) to synthesize graphics or human voice. Such synthesis techniques are well-known in the art. For example, graphics synthesis techniques are used today in set-top boxes capable of generating and displaying on-screen program guides. As another example, similar graphics synthesis techniques are used by cable networks such as CNN and CNBC, for example, to create moving banners. However, the moving banners that can be seen when viewing CNN or CNBC programming are created at the production studios of the cable networks, as opposed to being created at the receiver side by a set-top box, for example.

Speech synthesis software is available through commercial offerings from AT&T, IBM and Lucent, for example. The resulting synthesized components are then used to either replace or overlay corresponding components in the “generic” commercial program to produce a customized message for the target household. For example, synthesized custom voice can simply replace or overlay generic voice and/or audio components during the last five to ten seconds of a commercial. Similarly, synthesized custom graphics components, such as customized banners containing text messages, can simply be overlaid on top of the existing video components. Under both examples, it is not necessary to alter the underlying “generic” advertisement content.

Users who are not targeted or who do not have the appropriate type of receiver boxes continue to receive the “generic” advertising as before. Therefore, there is no disruption or adverse effect to existing advertising techniques. MPEG Transport mechanisms are currently used in the transmission of digital data via satellite and cable. In one embodiment of the invention, the capabilities of MPEG transport technology are used to transmit and receive the customization data related to each program to be customized.

In another embodiment, customization data may be sent along with analog TV channels. Typically, analog TV signals and methods of transmitting these signals are used to transmit channels 1-100, for example, by conventional cable TV service providers and systems. In this embodiment, the Vertical Blank Interval (VBI) lines or other “invisible lines” of the video frame may be used to carry the custom information. Use of the VBI lines for carrying close-captioned or other user data is well known in the art. Equipment to insert this type of data into the broadcast signal typically exists at broadcast stations or cable head-ends for closed caption or live caption purposes. The same, or similar, equipment can be used to insert custom data into the broadcast signal in accordance with one embodiment of the invention. In this embodiment, the TV receiver accesses and decodes the VBI data and delivers it to the appropriate sub-systems for processing and rendering. The TV receiver may be internal or external to the television set. For example, in one embodiment, the receiver may comprise a set-top box and associated software contained within the set-top box memory and executed by set-top box processing circuitry.

The text nature of the customization message has multiple advantages and facilitates the customization process as described below. These advantages are detailed in the following section and can be summarized as follows:

1. Creating customized messages in text form is the most economic method of producing customized advertising. No audio, video or graphical content for customization needs to be created at the head end. Utilizing well-known synthesis techniques, text data is converted into voice and/or graphics at the receiving end by software, firmware and/or hardware residing in the set-top boxes. This allows for the least amount of human involvement in the production of customized messages.

2. Low bandwidth requirement of text results in efficiency of transmission, obviating the need for additional tuners or complex overnight scheduling and storage of custom data.

3. Low bandwidth results in low latency. Only the actively viewed program needs to be customized where the customization data is sent very shortly before the program to be customized, in accordance with one embodiment of the invention.

4. Storage requirements in the set top will be minimized. Only data for one (i.e. active) program needs to be stored and this storage is very temporary in nature.

5. Least disruptive to the existing broadcast TV infrastructure including use of existing MPEG transport mechanisms.

### BRIEF DESCRIPTION OF THE DRAWINGS

FIG. 1 illustrates a block diagram of a system for automatic creation of a customized messages database, in accordance with one embodiment of the invention.

FIG. 2 illustrates elements of an MPEG transport stream and use of packetized data for program customization, in accordance with one embodiment of the invention.

FIG. 3 illustrates a block diagram of a receiver capable of creating custom graphics components, in accordance with one embodiment of the invention.

FIG. 4 illustrates a block diagram of a receiver capable of creating custom speech/voice components, in accordance with one embodiment of the invention.

### DETAILED DESCRIPTION OF THE PREFERRED EMBODIMENTS

The invention is described in detail below with reference to the figures, wherein like elements are referenced with like numerals throughout. In accordance with a preferred embodiment of the invention, a method and system for creating and providing customized content to target viewers is described below.

Creation of Custom Messages.

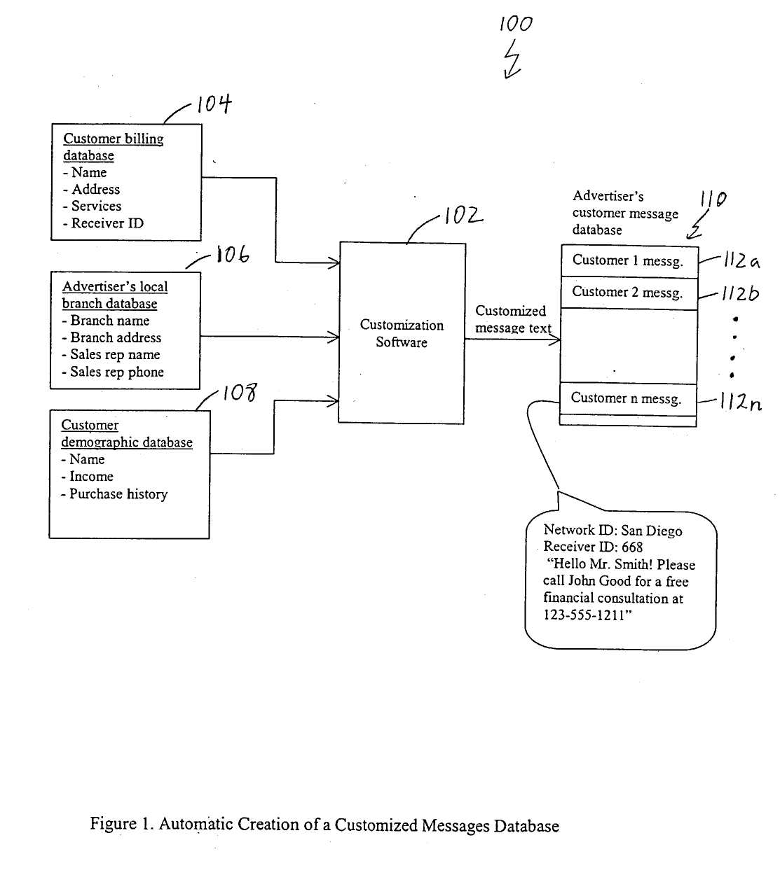

The advantage of text as a means of customization is in the ease of producing multiple customized messages. FIG. 1 illustrates a block diagram of a system 100 for creating custom messages, in accordance with one embodiment of the invention. The system 100 includes a central computer or server 102 which stores and executes customization software for creating custom messages in text form. In one embodiment, the server 102 is linked to different customer databases to extract relevant information of interest to an advertiser to identify target individuals or groups for receipt of custom messages. As shown in FIG. 1, these databases may include, for example, a service provider's customer billing database 104, an advertiser's local branch database 106, and a customer demographic database 108. The server 102 executes the customization software and searches for information of interest in one or more of the databases 104-108 to identify viewers or groups of viewers meeting specified criteria. After such viewers or groups are identified, the server 102 can create custom messages 112 for each target viewer or group and store them in an advertiser's customer message database 110.

In a preferred embodiment, the customer message database 110 can include messages such as message 112n which addresses individual viewers. Generating such a personalized message is achieved using known techniques. For example, an advertiser may search for all individuals living within a certain geographic region and then program the customization software to generate the following personalized message for each identified viewer: “Hello <insert sir name here>! Please call John Good for a free financial consultation at 123-555-1211,” as shown in FIG. 1.

It is understood that the above described databases 104-108 are exemplary only and that other types of databases may be utilized in accordance with the invention. Such databases may include, for example, a billing database of cable television subscribers including zip codes, addresses and perhaps viewing histories, consumer product databases containing previous purchase histories, direct marketing databases including age and income levels and the like, and so forth.

Transmission of Customization Message.

In one embodiment of the present invention, the customization data for different households is sent simultaneously with (or very shortly before) the transmission of the actual advertising content. The head end sends customization data for all channels and all programs to all users using the extra bandwidth available from the statistical multiplexing of multiple programs into a single transport. Individual households are addressed through the receiver ID (e.g. cable or satellite set top box ID or IP address) so that each receiver only decodes customization data targeted at that particular household. In a preferred embodiment, the head-end is aware of the channel being viewed through a back channel mechanism and sends only customization data for the actively viewed program. This back channel mechanism is well-known in the art and, therefore, need not be further described herein. The real time transmission of the customization data obviates the need for storage and scheduling of large amounts of customized data in the set top box for various channels and various program times. It also simplifies the task of associating the customization data and the related program to be customized as the latter follows immediately the former.

Real time transmission of custom content is possible in the present invention because it is transmitted in the form of text—the most compressed form of information. For example, ASCII text requires the lowest amount of bandwidth and thus lowest transmission latency compared to audio or video programs. This minimizes the amount of bandwidth required from the transmission facilities to each household. In a preferred embodiment, the extra bandwidth available from statistical multiplexing of digital video programs in a cable TV network is sufficient to serve a large number of households on a shared network and to provide each with its own customized messages of up to one hundred words, or more, each per advertising program. The low bandwidth requirements of text provide the added advantages that an additional tuner or overnight scheduling for the download of customized data, as described in prior systems such as that disclosed in U.S. Pat. No. 6,029,045, is not required.

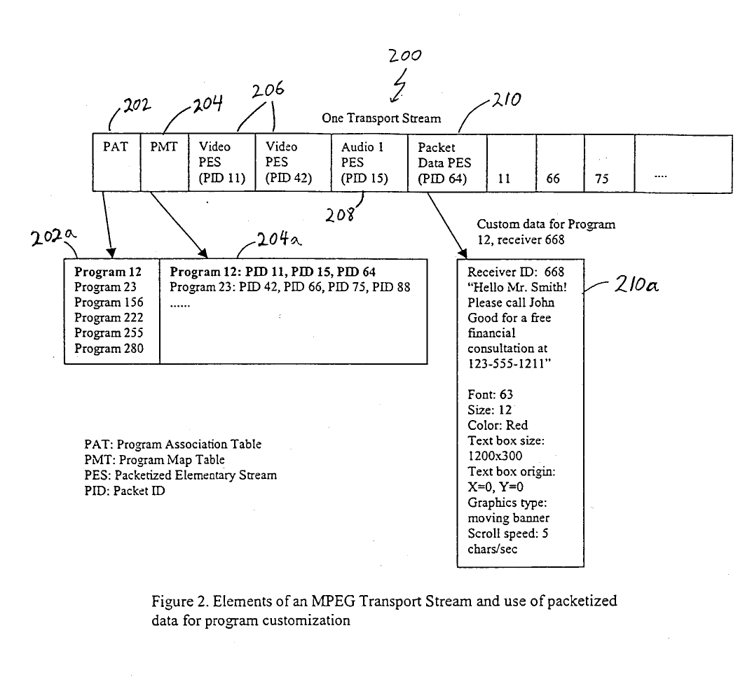

Referring to FIG. 2, when using an MPEG transport stream 200 (e.g. in digital cable and satellite TV transmission), one transport stream is made up of several (typically 4 to 6) programs along with a program association table (PAT) 202 which lists the ID of each program as shown in block 202a. Each program is composed of various elementary component streams, each stream including video packets 206, or audio packets 208, etc., corresponding to a specific program. In one embodiment, each packet contains 188 bytes worth of data. Each packet has its own unique id (PID) which distinguishes the packets of one program from packets belonging to other programs. The association between each program and its component elementary streams is contained in a Program Map Table (PMT) 204 which lists the PIDs for different component streams within the transport stream as shown in block 204a. Customization data for each advertising program is provided by a custom data stream containing custom data packets 210 associated with a specific advertising program. Further, each subscriber's separate customization data is uniquely received through a receiver address field (e.g., “Receiver ID: 668) in the packetized data which identifies the receiver box (e.g. IP address or set top box address) as shown in block 10a. Using this protocol, advertising messages can be tailored to different groups of households, down to individual household levels. The above-described MPEG digital transmission protocol is well-known in the art.

In another embodiment, customization data may be sent along with analog TV channels. Typically, analog TV signals and methods of transmitting these signals are used to transmit channels 1-100, for example, by conventional cable TV service providers and systems. In this embodiment, the Vertical Blank Interval (VBI) lines or other “invisible lines” of the video frame may be used to carry the custom information. Use of the VBI lines for carrying close-captioned or other user data is well known in the art. Equipment to insert this type of data into the broadcast signal typically exists at broadcast stations or cable head-ends for closed caption or live caption purposes. This same, or similar, equipment can be used to insert custom data into the broadcast signal in accordance with one embodiment of the invention. In this embodiment, the TV receiver accesses and decodes the VBI data and delivers it to the appropriate sub-systems for processing and rendering. The TV receiver may be internal or external to the television set. For example, in one embodiment, the receiver may comprise a set-top box and associated software contained within the set-top box memory and executed by set-top box processing circuitry.

It should be noted that not all receivers need to receive customization data. Data packets are received only by those receiver boxes for households intended to have their advertising customized. Other receivers receive and play back only the generic advertising without any modifications. Furthermore, not all advertisements will be customized. Only those intended by the advertisers to be targeted and customized will have associated data packets for customization. The needed data packets will be retrieved from a database at the head-end and placed into the transport stream. Alternatively, in another embodiment, the custom data packets may be placed into the transport stream by other components of the transmission equipment before reaching the head-end. Such other components, for example, could be video servers which contain advertising programs at the national level, digital ad-insertion equipment at the local level, and similar other elements of the end-to-end transmission facility which exist upstream from the head-end equipment.

Creating Customized Program in the Receiver.

In a preferred embodiment, creation and insertion of the customized content may be achieved through two mechanisms—graphic overlay or voice overlay. Under both schemes, the start of a commercial is detected through cue tones which are typically inserted by broadcasters into the programming stream before the start of advertising messages.

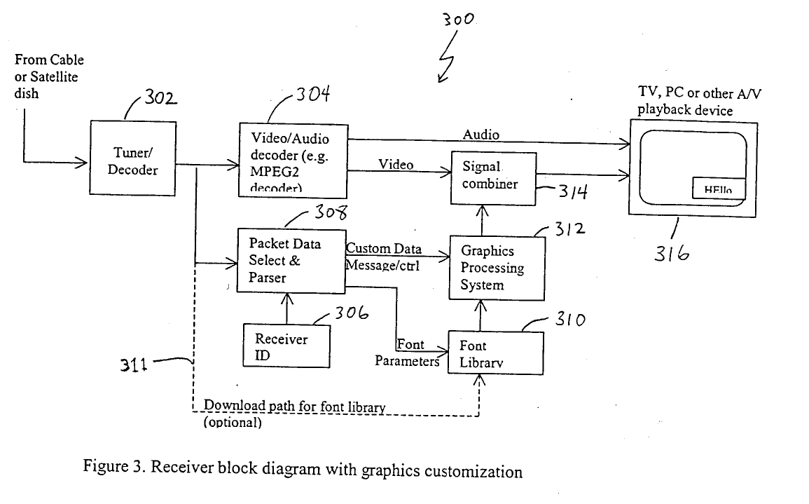

Referring to FIG. 3, a block diagram of a receiver system 300 capable of generating customized graphic overlays is-illustrated, in accordance with one embodiment of the invention. When utilizing a graphic overlay approach, text of a customized message is received by a tuner/decoder 302 which is tuned to receive and decode data from a selected channel. The video and audio packets for a corresponding program being broadcast on the received channel is provided to a video/audio decoder for further processing. The receiver ID is stored in a receiver ID unit 306 which, in one embodiment, is a read-only memory (ROM) storing the receiver ID data. Custom data packets corresponding to a receiver ID provided by the Receiver ID unit 306 are provided to a packet data select & parser unit 308 that parses the packet contents into display font parameters and custom message parts. This data is used to convert the text into a specified graphical display font provided by a font library 310. Font data and other custom graphics data are provided to a graphics processing system 312 which creates the graphic objects to be overlaid into the decompressed video stream in one of several forms. Examples of the graphical objects which could be used for this purpose are pop-up screens, still banners, moving banners and similar others. In one approach, the physical location and size of the graphics is fixed beforehand (for example the lower right hand corner, 200 pixels wide by 300 pixels high). In a second approach, the location and size can be communicated along with the customized data itself. In this second approach, the physical dimensions (height and width) as well as the location (coordinates) of the text box are communicated through binary representations. Further, in each of the approaches above, information such as the font types, font sizes, moving or fixed nature of the text can be customized by passing the relevant parameters from the head-end along with the customized data in the packet data elementary stream (FIG. 2). Following demodulation and decoding, the receiver selects the data packet addressed to it appropriately and the relevant parameters are parsed and passed to the graphics processing system 312 to create the appropriate graphics for overlay onto the program. The process of overlaying the graphic object onto the generic program video display is accomplished by signal combiner 314. The combiner 314 combines or “mixes” the graphic objects with the video data received from the video/audio decoder 304 so as to create a desired overlay of the graphic object on top of the video that is ultimately displayed by a television set 316. Such combiners for overlaying banners or graphics (e.g., the NBC Peacock graphic overlay) onto television programs are well-known in the art.

The graphics processing system 312 uses the font library 310 to create a variety of font types for display. This font library is either pre-existing in the receiver or can optionally be downloaded from the head end via a download path 311, as shown in FIG. 3, for more flexible customization. The graphic objects described above can be used to customize the underlying message of the advertiser for the specific viewer (e.g. location of the closest store to the viewers' house), to provide information on an affiliate of the advertiser (e.g. Safeway's promotion when a beer commercial is broadcast) or an independent message targeted to the customer can be sent (e.g. Bank of America message during a Safeway commercial). This can also provide the service providers with an additional source of revenue for the same amount of commercial air time.

Moving, or scrolling, banners are a familiar and effective graphical means for customization of advertising. The results of using scrolling banners by financial and news networks indicate their effectiveness as a parallel mechanism for the communication of information to the viewer, in addition to the audio/video component. For scrolling banners, the parameters that need to be communicated from the head-end to the receiver (through the data packet) include banner height, banner width, Euclidian location of the banner (e.g. x- and y-coordinates of the lower right hand corner), the scroll speed (e.g. number of new text characters displayed per second) and the character font used to display the moving text in the banner. In addition, more than one scrolling banner can be used by stacking one on top of the other, usually starting at the bottom of the screen. A combination of fixed (still) and moving banners could also be used. Further, different types of graphical objects can be combined (e.g. a pop-up graphics along with a moving banner, etc.) to display multiple simultaneous text messages to the viewer. Again, in the preferred embodiment, the generation of these graphical objects is performed by the graphics processing system 312 contained in the set top box.

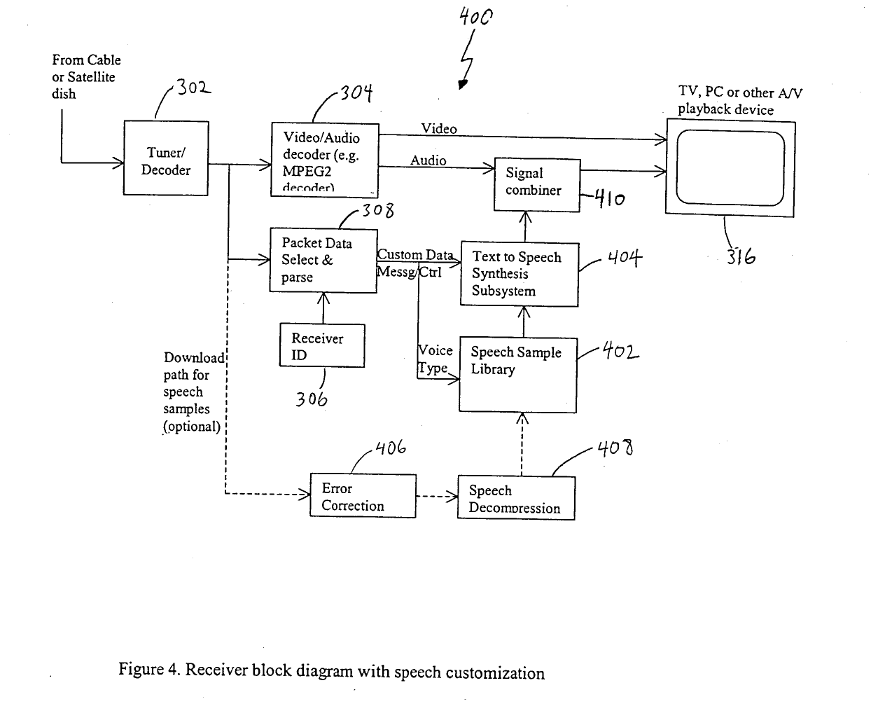

Referring to FIG. 4, a block diagram of a receiver system 400 capable of creating voice or speech overlays is illustrated, in accordance with one embodiment of the invention. Similar to the system 300 shown in FIG. 3, the system 400 also includes a tuner/decoder 302, a video/audio decoder 304, a receiver ID unit 306, packet data select & parse unit 308 which may be similar or identical to the corresponding devices described above with respect to FIG. 3. The system 400 further includes a speech sample library 402 for providing speech samples to a text to speech synthesis subsystem 404. In this scheme the text of a customized message is converted to human voice by text to speech synthesis subsystem 404 using well-known techniques. The synthesized voice component is then provided to an audio signal combiner 410 which combines the synthesized speech data with the audio data of a selected program. In a preferred embodiment, the synthesized speech is overlayed onto the existing audio content of a program by using either an unused audio channel to provide the synthesized voice or replacing audio data in a default (generic) audio channel. These audio channels are then provided to the television 316. Note that when unused audio channels are utilized by the synthesized speech data, the synthesized speech may simply be “played back” by the television 316 simultaneously with the generic audio playback. Unused audio channels are sometimes present in television program data streams and, therefore, may be advantageously utilized in accordance with one embodiment of the present invention. The above-described techniques of “mixing” audio signals are well-known in the art.

In one embodiment, the timing of the voice overlay may be specified beforehand (for example, starting at the 10 ^{th} second from the start of the commercial) or can be variable through a time parameter which is sent from the head-end along with the customization data. In one embodiment, the customized data is sent in advance so as to provide enough time for the text to speech synthesis subsystem 404 to perform the speech synthesis operations (for example, approximately sixty seconds) before the actual playback time of the customized message.

Similar to the graphical overlay case described above, three applications can be supported through this voice overlay function. The customized voice message can carry information specific to the viewing household about the underlying advertisement, it can carry information about an affiliate/partner of the advertiser or it can carry a completely independent message.

The text to speech synthesis system 404 typically uses a library 402 of digitized speech samples (or phonemes) consisting of speech waveforms for a specific voice type. These speech samples are either previously stored in the set top box (e.g. a male, a female and a child voice sample library) or can be downloaded via download path 405 to the receiver 400 at a convenient time (e.g. late night hours) or any other time before the reception of the advertising program. In the embodiment where speech samples are downloaded to the receiver, to reduce the transmission bandwidth, the digitized speech samples in a preferred embodiment are first compressed (speech compression). The compressed speech waveforms are then protected through error-correcting codes (e.g. Turbo codes, convolutional codes or Reed-Solomon codes) before transmission from head-end to the receiver. Any transmission errors are then corrected by an error correction unit 406 in the receiver 400. The corrected compressed speech waveforms are then decompressed by a speech decompression unit 408 and thereafter stored for use in the speech sample library 402.

The customization approach described above is the least disruptive to the existing methods of creating and broadcasting television programming content. Although the receiver systems 300 and 400 have been described separately for ease of discussion, it is readily apparent to those of ordinary skill that the two systems may be integrated within one system to provide the functionality of both systems as described above. As described above, the invention provides for the customization of programs with minimal changes to the way broadcast TV and advertising is carried out today. In preferred embodiments, no separate channel for the transmission of customized programs for targeted user needs to be provided. No individual scheduling of targeted programs by the broadcasters or service providers is necessary. Viewers continue to view the same programs on the same channels with advertising breaks occurring at the same time except that portions of the advertising will potentially be customized and different for different viewers. This continuity with the existing methods of TV broadcasting is a significant factor promoting the adoption of the customization technology provided by the present invention by the broadcast industry and service providers.

In summary, the invention described here has the following characteristics:

Low bandwidth requirements to transmit customized content

What we claim is:

1. A system for communicating video programs along with customized program content, in the form of data packets with custom content, the system comprising:
Means for creating a plurality of customized data packets corresponding to a plurality of viewing population segments with each population segment assigned one or more data packets;
Means for scheduling and synchronizing the transmission of customized data packets at a specific time point of the video program, and transmitting this composite program, consisting of video and data, to the set-top box residing at a viewer's residence;
Means in the set-top box for selecting the appropriate customized data packets from the composite program being received based on a plurality of parameters;
Means in the set-top box for rendering of the selected data packets just received, into graphical, voice or audio program components based on instructions embedded in the data packets.
Means in the set-top box for overlaying the said selectively received and rendered program components on top of the video program being received in real-time to play back the combined video program and the customized overlay on a video display device, in order to create a customized program relevant to that particular viewer.

2. The system of claim 1, wherein the said video program being customized is an advertisement within existing television programs.

3. The system of claim 1, wherein the video program being customized is advertisements within pre-recorded video used in video-on-demand service offering.

4. The system of claim 1, wherein the video program being customized is general programming content that is intended to have an advertisement overlay.

5. The system of claim 1, wherein the program being customized is an infomercial resulting in targeted offerings to different segments of the viewing population.

6. The system of claim 1, wherein said means of creating customized data packets consists of a software program correlating one or more marketing databases, to automatically and selectively fill in specific fields of a generic text message.

7. The system of claim 1, wherein said parameter for identifying the population segment to which the viewer belongs, is stored ahead of time in the set-top box.

8. The system of claim 1, wherein said means of communicating video programs and data packets is based on Motion Pictures Experts Group, or MPEG, transport technology as deployed by cable TV or satellite TV operators.

9. The system of claim 1, wherein said means of transmitting customized data packets to the set-top box is the private-data section of an MPEG transport.

10. The system of claim 1, wherein said means of transmitting customized data packets is an Internet-based video delivery system to a personal computer system.

11. The system of claim 1, wherein said means of transmitting the customized data packets is a dedicated frequency channel available through a dedicated tuner in the set-top box.

12. The system of claim 1, wherein said means of transmitting the customized data packets is the vertical blanking interval, or VBI, of the analog video.

13. The system of claim 1, wherein rendered graphical and audio components are used to selectively replace a segment of a video program, or to fill in a blank segment of a video program.

14. The system of claim 1, wherein one means of customizing the program is using MPEG-4 to create new video content.

15. The system of claim 1, wherein customized voice overlays are created from a speech synthesis software running on the set-top box.

16. The system of claim 1, wherein customized voice overlays are created from compressed voice packets by a speech decompression software running on the set-top box.

17. The system of claim 1, wherein a cue-tone is used to determine the insertion point of the customized data packets for advertisement enhancement.

18. The system of claim 1, wherein a digital signal is used to determine the insertion point of the customized data packets into the program video.

19. The system of claim 1, wherein said means of rendering in the set-top box include ability to control desirable aspects of the graphics, voice or audio consisting of the physical shape and location, color, speed of movement, timing of appearance and disappearance, loudness and similar features based on instructions embedded in the data packets;

20. The system of claim 1, wherein an error-correction mechanism is used in the set-top box to correct for transmission errors in the data packets.

21. The system of claim 1, wherein graphical libraries are downloaded to the set-top box ahead of time.
